(19) United States
(12) Patent Application Publication
(10) Pub. No.: US 2004/0239634 A1
(43) Pub. Date: Dec. 2, 2004

(54) Operator control panel for operating machine tools or production machines

(75) Inventors: Rainer Adolf, Ansbach (DE); Jens-Andre Bunk, Staffelstein (DE); Sven Moniac, Langenzenn (DE); Franz-Josef Weigert, Feucht (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/846,360

(22) Filed: May 14, 2004

(30) Foreign Application Priority Data
May 14, 2003 (DE) 103 21 663.4

(51) Int. Cl. G09G 5/00

(52) U.S. Cl. 345/168

(57) ABSTRACT

An operator control panel for operating machine tools or production machines has a touch-sensitive keyboard with a customer-specific shape and configuration. The control panel includes a face plate with a shape and configuration adapted to a shape of the touch-sensitive keyboard, and frame profiles matching the outside contour of the face plate for receiving the face plate. A user-selectable process for planning the operator control panel before manufacturing is also described. The disclosed operator control panel can be easily and inexpensively customized.

### CROSS-REFERENCES TO RELATED APPLICATIONS

This application claims the priority of German Patent Application, Serial No. 103 21 663.4, filed May 14, 2003, pursuant to 35 U.S.C. 119(a)-(d), the disclosure of which is incorporated herein by reference.

### BACKGROUND OF THE INVENTION

The present invention relates to an operator control panel for operating machine tools or production machines, wherein the operator control panel includes a touch-sensitive keyboard of a shape and configuration adapted to specific customer requirements.

Such operator control panels for operating machine tool or production machines are generally known. These operator control panels are used to monitor the production process as well as to input parameters or for user-operated control of machine tools or production machines.

Commercially available operator control panels consist essentially of a touch-sensitive keyboard and a plastic front panel that forms a housing to which the touch-sensitive keyboard is attached.

The plastic front panel has been fabricated hitherto with customized tools, for example a mold for a corresponding plastic injection molding machine. Such molds can be quite complex and therefore expensive so that front plates for modern operator control panel with a customized shape and configuration tend to be costly due to the special tooling, especially for small and moderate quantities. For small quantities, particular shapes and features, in particular special designs, may necessitate substantial compromises. Moreover, the location of the features forming the system, such as a display, an analog manual input or an interface provided on the face plate can be costly to change when using plastic front faces produced by special molds. The expense associated with implementing a new product variation can equal those of a new development.

It would therefore be desirable and advantageous to provide an improved operator control panel for operating a machine tool and production machine, which obviates prior art shortcomings and can be easily customized.

### SUMMARY OF THE INVENTION

According to one aspect of the invention, an operator control panel for operating a machine tool or production machine includes a touch-sensitive keyboard with a customer-specified shape and configuration. The control panel further includes a face plate that conforms to the shape and configuration of the touch-sensitive keyboard and secures the touch-sensitive keyboard, and a plurality of frame profiles dimensioned according to an outside contour of the face plate for receiving the face plate.

According to another aspect of the invention, a method of producing an operator control panel includes the steps of providing a configuration program that enables a user to select a shape and a configuration of the operator control panel, and based on the user selection, executing the configuration program for planning production of the operator control panel before the operator control panel is manufactured. This allows planning and rapid development and/or distribution/marketing of new products that include customized operator control panels.

According to an advantageous embodiment of the invention, the operator control panel can include a support plate conforming to the shape of the face plate, whereby the support plate can form a rear wall of the operator control panel. This ensures a reliable housing termination.

The face plate and/or the frame profiles and/or the support plate of the operator control panel can be made of metal, which facilitates manufacture of a desired shape and configuration of the operator control panel.

According to another advantageous embodiment of the invention, the touch-sensitive keyboard and the face plate can include one or more openings for, for example, a display, a manual analog input, a short-stroke key and/or a communication interface. The operator control panel can be individually adapted to specific customer requirements by customize openings for any desired shape and/or number for control elements or displays located on the touch-sensitive keyboard or face plate.

Advantageously, the communication interface can be implemented as a USB interface, a FireWire interface, an Ethernet interface, and/or Profibus interface.

According to yet another advantageous embodiment, the shape and configuration can be selected by a step-by-step process and visualized. Moreover, the configuration program can advantageously compute the cost and/or price of the operator control panel after is has been configured. The user can then immediately change the configuration if the cost and/or the price are too high.

The product development time can be significantly reduced by having the configuration program, after user selection, generate production-relevant drawings for the operator control panel.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is an exploded view of an operator control panel;

FIG. 2 shows the application of a configuration program for selecting the display size;

FIG. 3 shows the application of a configuration program for selecting the SoftKey-Fields;

FIG. 4 shows the application of a configuration program for selecting a keypad;

FIG. 5 shows a selection of minimum dimensions of the operator control panel and a cost/price result obtained with the configuration program; and

FIG. 6 is a process flow diagram for planning production the an operator control panel of FIG. 1.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

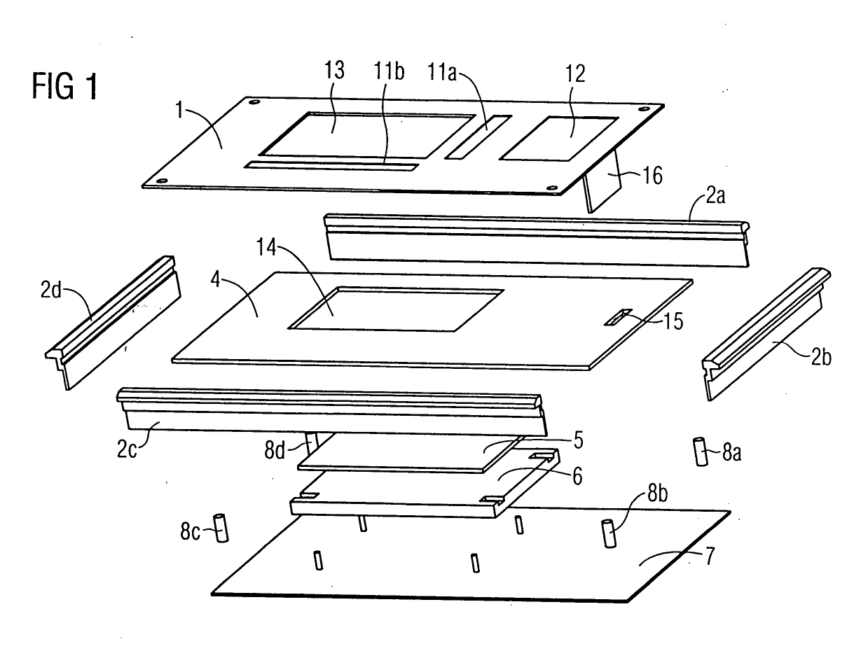

Turning now to the drawing, and in particular to FIG. 1, there is shown an exploded view of a basic design of an operator control panel according to the invention. FIG. 1 shows a touch-sensitive keyboard 1, which is secured to a face plate 4 adapted to a shape and configuration to the touch-sensitive keyboard 1. Four frame profiles 2a, 2b, 2c and 2d match lateral dimensions of the face plate 4 and can be assembled to hold the face plate 4. The touch-sensitive keyboard 1 includes integrated to SoftKey fields 11a and 11b as well as a keypad 12. In addition, the touch-sensitive keyboard 1 has an opening 13 and the face plate 4 has a matching opening 14 for a display 6. A glass pane 5 for protecting the display 6 is mounted between the face plate 4 and the display 6. A support plate having a shape that matches the shape of the face plate 4 forms a rear wall and terminates the housing. The face plate 4 is connected with the support date 7 by fasteners 8a, 8b, 8c and 8d. The display 6 is attached to the support date 7 by four smaller fasteners that are not labeled with reference numerals in FIG. 1 for sake of clarity.

Conventional operator control panels of machine tools or production machines have frame profiles 2a, 2b, 2c and 2d and a face plate 4 that are fabricated as a single contiguous plastic part, also referred to as plastic front plate.

Customers increasingly require that operator control panels are customized for a machine tool or production machine. For example, the customer should be able to specify the position and number of SoftKey fields, which each can have a variable number of SoftKeys, as well as the key fields and the position and the size of the display, in particular the height and width of the display, and the shape, in particular the height and width of the operator control panel.

The specifications of touch-sensitive keyboards can be easily and cost-effectively adapted to specific customer requirements and then manufactured according to these specifications. However, the plastic front poses a different situation. A change in the shape and/or configuration of the touch-sensitive keyboard requires in most cases a change in the plastic front plate. As a result, a dedicated to injection mold for the plastic front panel may have to be produced for each design of the touch-sensitive keyboard. As mentioned above, the manufacture of such injection molds is quite complex and expensive, so that the expenses can only be justified for larger production quantities of the operator control panels.

This situation can be improved with the operator control panel according to the invention. Instead of the conventional plastic front panel, the keypad 1 in FIG. 1 is attached to a face plate 4 that can be made of metal. Such face plate 4 can be economically produced even in small quantities from sheet metal, for example, by punching. The frame profiles 2a, 2b, 2c and 2d matched to the face plate 4 can also be readily made of metal profiles, even in small quantities. For this purpose, the frame profiles are cut from a long profile rail to match the specified length and width of the face plate 4 for the touch-sensitive keyboard 1. Accordingly, the commonly used plastic front panel is thereby replaced by a modular system composed of four frame profiles 2a, 2b, 2c and 2d and a face plate 4. The modular system is implemented similar to a picture frame. Even a small number of operator control panels can then be cost-effectively manufactured. In addition to the openings 13, the touch-sensitive keyboard 1 can also include additional openings, for example for a communication interface or an analog manual input. The face plate 4 can be manufactured with matching openings. In the depicted embodiment, the face page 4 has an additional opening 15 for routing a ribbon cable 16 from the touch-sensitive keyboard 1.

The customer frequently desires a plastic face plate with a specific color, which could hitherto only be produced by using a dyed plastic. With the operator control panel of the invention, only the metal frame profiles 2a, 2b, 2c and 2d have to be painted in the desired color.

Likewise, the face plate 4 can also be provided with lettering, for example for the USB connection or/and manual analog input.

In addition, short stroke keys can also be incorporated in the touch-sensitive keyboard 1 and the face plate 4 by providing additional openings.

The operator control panel according to the invention can also be used in damp environments (e.g., IP 54, IP 55, and NEMA 4) by incorporating corresponding seals, for example, between the face plate 4 and the frame profiles 2a, 2b, 2c and 2d.

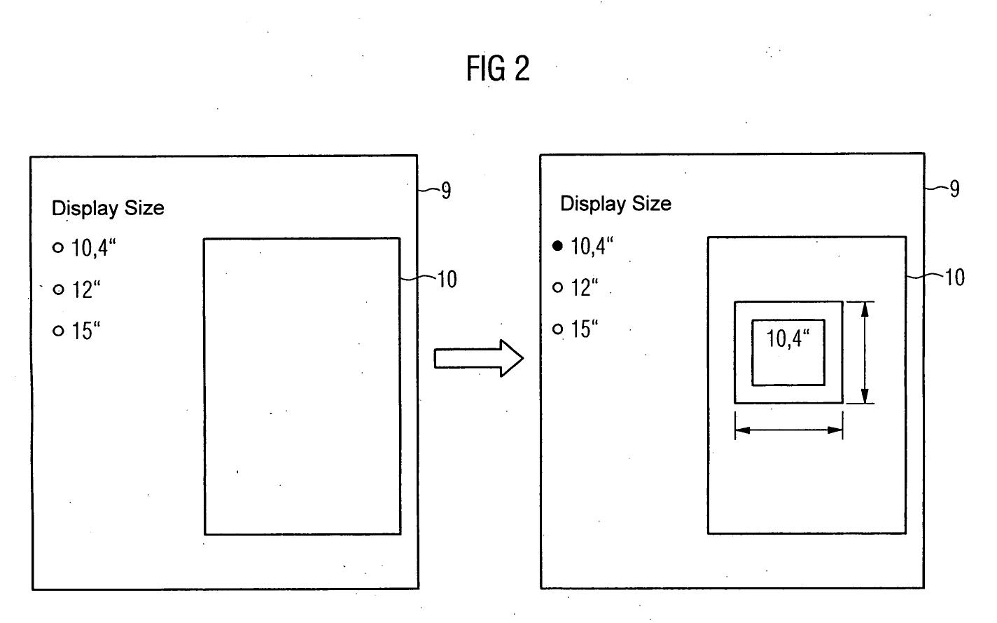

Advantageously, a user can plan the operator control panel according to the invention with the help of the configuration program by selecting possible configurations before the operator control panel is actually manufactured. FIGS. 2 to 5 show exemplary display windows 9 that are generated on a display screen by the exemplary configuration program. The configuration program can be executed, for example, on a conventional personal computer or laptop computer or the like. The user must initially define the size of the display. For example, in the embodiment illustrated in FIG. 2, the display size can be, for example, 10.4 cm, 12 cm or 15 cm diagonal. After selecting the display size by clicking the button of the selected display size (in the embodiment depicted in FIG. 2, a display screen width of 10.4 cm diagonal is selected), the corresponding display with the desired dimensions is shown in a preview window 10.

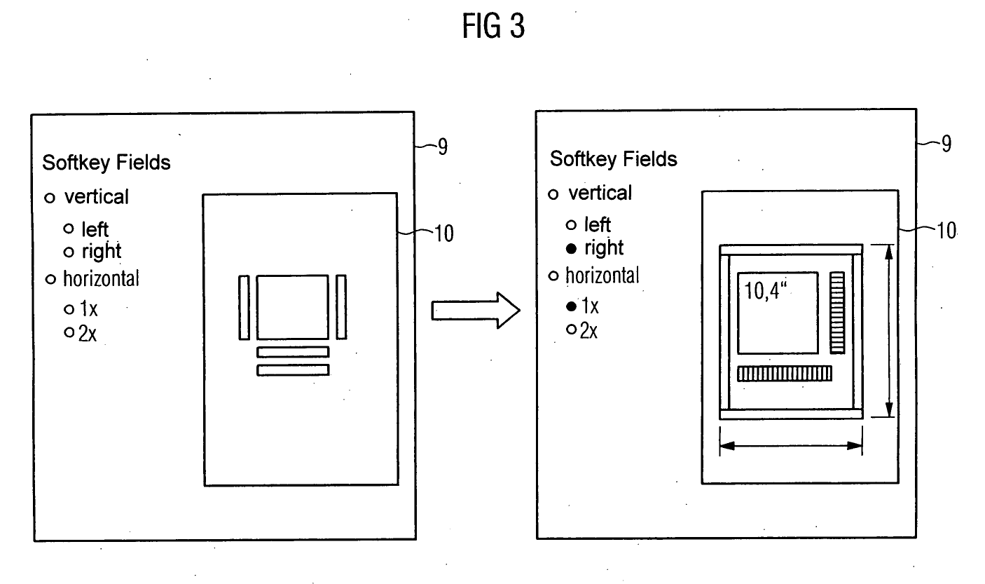

As shown in FIG. 3, the user can then define the position and number of SoftKey fields by a mouse click, with the result again displayed in the preview window 10.

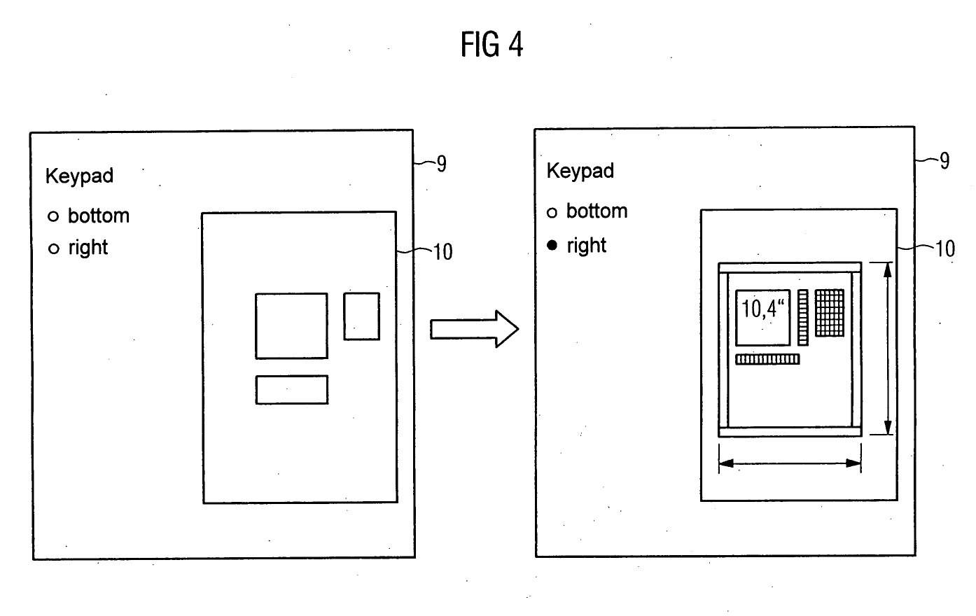

The location of the keypad can then be selected in the same manner, as shown in FIG. 4. The result again displayed in the preview window 10.

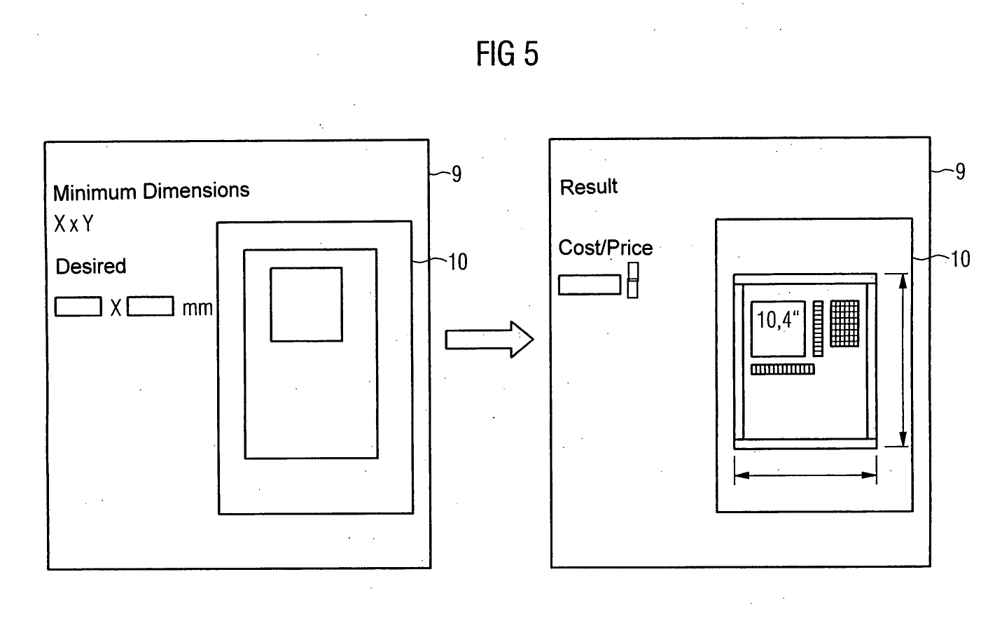

Finally, as shown in FIG. 5, other user-selectable dimensions of the operator control panel can be displayed to the user. A view of the selected operator control panel is displayed to the user in the preview window 10. The cost or price for the selected shape and/or configuration of the operator control panel can be indicated in a different field.

It will be understood that in practice additional configurable parameters and components can be provided or implemented. The steps indicated in FIGS. 2 to 5 are therefore to be understood as merely exemplary and illustrative.

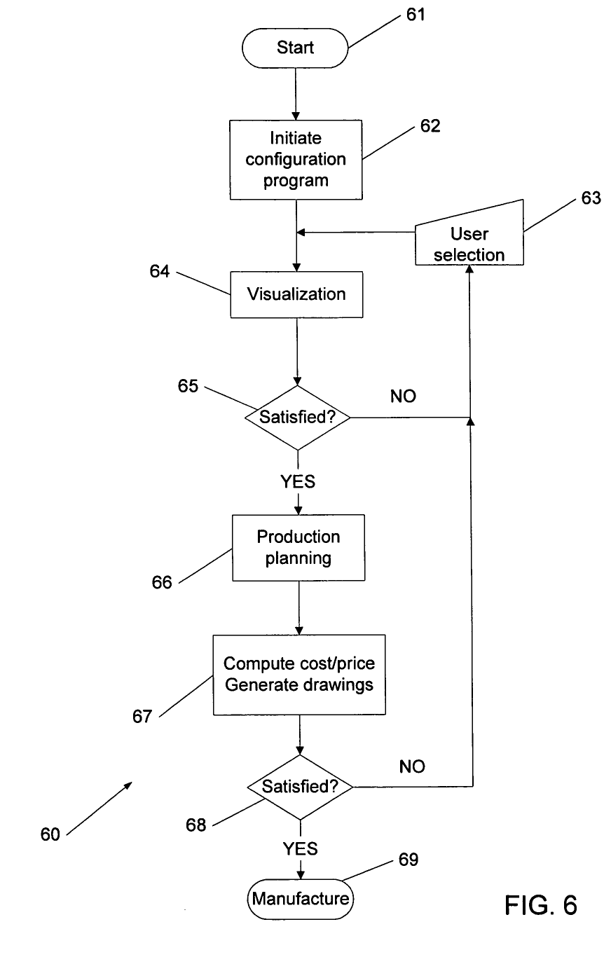

FIG. 6 summarized the steps depicted in FIGS. 2-5 in form of a process flow diagram 60. The process is started in step 61, and the configuration program is initiated, step 61. The configuration program generates the windows 9 and 10 illustrated in FIGS. 2-5. A user selects in step 63 the desired parameters for the control panel, for example, from the indicated options, which are the visualized in window 9, step 64. If the user is not satisfied with the layout, step 65, the process returns to step 63 where the user can be prompted for an alternative selection. Conversely, if the user is satisfied with the layout of the control panel, step 65, the planning stage of the configuration program is executed, step 66. The configuration program can then compute a cost/price estimate for manufacturing the control panel, step 67, and optionally also generate drawings, for example, for a CAD system. If the user is not satisfied with the results, step 68, for example because the estimated cost for the panel are too high, the process 60 returns to step 63, where the user can make suitable modifications to the design.

Conversely, if the user or customer agrees to the price and cost for the operator control panel, then the configuration program can produce actual manufacturing drawings, such as CAD drawings, for the selected configuration of the operator control panel, step 68, and take the necessary steps for manufacturing the operator control panel, step 69.

It will be understood that the face plate and the frame profiles need not be made of metal, as described above with reference to the described exemplary embodiments. The face plate and the frame profiles can also be made of other materials. However, metal parts can be more easily adapted to the touch-sensitive keyboard.

It should be noted here that machine tools can include single-axis or multi-axes lathes, milling machines, drilling machines or grinding machines. Machine tools also include processing centers, linear and rotary transfer machines, laser machines or rolling and gear-making machines. All these machines have in common, that a material is machined, optionally along multiple axes. Production machines also include, for example, textile, plastics, wood, glass, ceramics or rock processing machines. Production machines also include machines for forming and packaging, printing or conveying, as well as pumps, fans, lifting gear and robots.

It should also be mentioned that conventional front panels can also be made of cast aluminum rather than of plastic. Cast aluminum front panels are also manufactured with expensive and complex injection molds, so that these front panels pose the same problems as the plastic front panels.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. An operator control panel for operating a machine tool or production machine, comprising:
a touch-sensitive keyboard having a shape or configuration, or both, adapted to specified customer requirements,
a face plate conforming to the shape or configuration of the touch-sensitive keyboard and securing the touch-sensitive keyboard, and
a plurality of frame profiles dimensioned according to an outside contour of the face plate for receiving the face plate.

2. The operator control panel of claim 1, further comprising a support plate conforming to the shape of the face plate, with the support plate forming a rear wall of the operator control panel.

3. The operator control panel of claim 1, wherein the face plate is made of metal.

4. The operator control panel of claim 1, wherein the frame profiles are made of metal.

5. The operator control panel of claim 2, wherein the support plate is made of metal.

6. The operator control panel of claim 1, wherein the touch-sensitive keyboard and the face plate include one or several openings for at least one component selected from the group consisting of a display, a manual analog input, a short-stroke key and a communication interface.

7. The operator control panel of claim 6, wherein the communication interface comprises at least one interface selected from the group consisting of a USB interface, a FireWire interface, an Ethernet interface, and a Profibus interface.

8. A method of producing an operator control panel, comprising the steps of:
providing a configuration program that enables a user to select a shape or a configuration of the operator control panel, and
based on the user selection, planning production of the operator control panel before the operator control panel is manufactured.

9. The method of claim 8, wherein selecting the shape or configuration is performed by a step-by-step selection and visualization of the configuration by the user.

10. The method of claim 8, wherein the configuration program, after user selection, computes a cost or price of the operator control panel.

11. The method of claim 8, wherein the configuration program, after user selection, generates production-relevant drawings for the operator control panel.

12. A computer program for user-selected planning of an operator control panel, said computer program embodied on a computer-readable medium for execution by a computer, the computer program causing the computer to:
prompt a user to select a configuration of the operator control panel, and
based on the user selection, provide the user with production-related data for producing the operator control panel with the selected configuration, before the operator control panel is manufactured.

13. The program of claim 12, wherein the production-related data include a cost or price of the operator control panel.

14. The program of claim 12, wherein the production-related data include a production-related drawing for the operator control panel.

15. The program of claim 12, wherein if the user rejects the production-related data, the user is prompted to select a new configuration.
